(19) United States
(12) Patent Application Publication
(10) Pub. No.: US 2010/0311442 A1
(43) Pub. Date: Dec. 9, 2010

(54) WIRELESS MESSAGING SYSTEM

(76) Inventor: Natan Epstein, Beverly Hills, CA (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 12/310,237

(22) PCT Filed: Apr. 18, 2006
(86) PCT No.: PCT/US2006/014596

§ 371 Date: Feb. 13, 2009

(51) Int. Cl. H04W 4/12

(52) U.S. Cl. 455/466

(57) ABSTRACT

Messages are routed via a cellular communications network to multiple cellular communications receivers configured for answering calls placed to a common subscriber number, such that a message originated with a single cellular call may reach multiple recipients. The geographic area of message distribution may be controlled by selectively enabling different cell sites for calling particular subscriber numbers. The cellular receivers may have message storage capabilities for subsequent replay of received messages. Message storage may be provided by downloading messages to a conventional telephone answering device also connected for landline telephone call answering, thereby adding received cellular messages to recorded landline telephone messages.

### BACKGROUND OF THE INVENTION

1. Field of the Invention

This invention pertains to the field of cellular wireless communications, and more particularly relates to wireless messaging using cellular communications networks.

2. State of the Prior Art

Cellular wireless communication systems are widely deployed and used for mobile telephone and other communications. Current use typically involves communications between individual subscribers each equipped with a handheld cellular telephone unit. The mobile units are each assigned unique telephone numbers and cellular communications are typically private between parties known to the cellular network.

The mobile handsets communicate via a cellular network which includes transponder cellsites each having a limited area of coverage and located so as to provide contiguous areas or cells of radio coverage over a larger area of service. The mobile handsets periodically transmit an identification signal which is used to locate the handset within the coverage area of one or more cellsites. The cellsites in turn are networked by trunk lines and are managed by a central control office. The location of active handsets received by all of the cellsites is known to the digital control system, so that a call placed to a particular wireless handset is placed, either from another mobile handset or from a conventional landline telephone, can be directed to a cellsite within radio range of the target handset. Two way communication, by landline for example, can then be established from the central control office to the appropriate cellsite, and the link completed by two-way radio communication between the cellsite and the handset. A detailed description of the operation of cellular communication networks is not necessary here as the topic is relatively complex and the information is available from publicly accessible sources.

Communications using such cellular networks are directed to specific subscribers, that is, to particular telephone numbers in a cellular telephone network. While messaging services exist for directing communications such as text messages to multiple recipients, each of the message recipients is also specified to the cellular network and known to the sender.

### SUMMARY OF THE INVENTION

This invention provides a wireless messaging system which in a presently preferred embodiment makes use of a cellular communications network such including a number of cellsites for routing wireless messages to subscribers located within range of one or more of the cellsites. The cellular communications network may be of the type which is normally configured for monitoring the presence and location of individual active mobile handsets relative to different cellsites, such that messages or calls addressed to any one mobile number can be routed through an appropriate cellsite within range of the handset corresponding to that mobile number. For purposes of this invention, however, the cellular network is configured to operate without monitoring or verifying the presence of mobile handsets corresponding to mobile numbers assigned to a special category of subscriber here referred to as a broadcast subscriber. The broadcast subscriber is assigned a broadcast number which may be a particular mobile telephone number.

Calls placed to a broadcast number are transmitted by one or more broadcasting cellsites without verifying the presence of a mobile handset corresponding to that broadcast number in the area covered by those one or more cellsites. The broadcasting cellsites are selected by the broadcast subscriber, for example, as part of a subscription agreement with the cellular network service provider. The one-way message broadcasting aspect of the cellular network may coexist with conventional two-way mobile communications by the network.

A number of cellular communications receivers are installed at recipient sites located within range of the broadcast cellsites. Each receiver is configured to accept calls routed to a broadcast number. Multiple such receivers may be configured to accept calls addressed to a same broadcast number through the broadcast cellsite or cellsites, such that multiple receivers may receive a call placed to a single broadcast number. A particular broadcast call or message may be broadcast through more than one cellsite so as to cover a wider geographic area of reception. Also, a broadcast call may be stored by the cellular network provider for subsequent broadcast through one or more cellsites, for example, during off-peak times of network usage.

In typical cellular communications networks the cellsite initiates a two-way call or communication with a mobile handset by assigning available frequencies or channels for the communication session, including a receive frequency and a transmit frequency for the mobile handset. The cellular broadcast receivers used in the preferred embodiment of the present invention lack transmission capability, so that no assignment of transmit frequency is needed. However, the receivers are preferably responsive to communications channel assignment control signal transmitted by the broadcasting cellsite, such that the receiver switches to a receive frequency assigned for the particular broadcast by the broadcasting cellsite, so that the cellular broadcast can be made over a frequency then available to the broadcasting cellsite. This assignment of receive frequencies can be made in the conventional manner currently employed with conventional two way mobile telephone handsets, for example.

The cellular receivers preferably have message storage capabilities, such as digital storage, for subsequent replay of received messages.

In one embodiment of the invention the cellular broadcast receivers are stand alone units with built in message playback capability, including for example, audio playback of voice messages, and for this purpose may have an audio amplifier and loudspeaker as part of the receiver unit.

In another embodiment of the invention the cellular broadcast receivers cooperate with a conventional telephone answering device of the type commercially available for answering calls to landline telephones and storing voice messages for subsequent replay. In this embodiment the cellular receivers may be configured for receiving operating power from a landline telephone jack, and may be also configured for downloading stored cellular messages to the conventional telephone answering device for subsequent replay by the conventional answering device. In this latter embodiment, the cellular broadcast receivers may be built as a single unit together with the landline telephone answering device, for example, in a common housing.

In still other embodiments of the invention the cellular receivers may be preprogrammed for answering to one or more broadcast numbers. The cellular receivers may be reprogrammable by end users for answering to different or additional broadcast numbers.

These and other improvements, features and benefits will be better understood by reference to the following detailed description of the preferred embodiments.

### BRIEF DESCRIPTION OF THE DRAWINGS

FIG. 1 depicts in schematic form a group of cellsites comprising part of a larger cellular communications network and a number of cellular receivers located in some of the cell areas of coverage provided by the cellsites; and

FIG. 2 is a perspective view of a cellular receiver unit according to this invention connected between a wall mounted telephone jack and a typical telephone answering device.

### DETAILED DESCRIPTION OF THE PREFERRED EMBODIMENTS

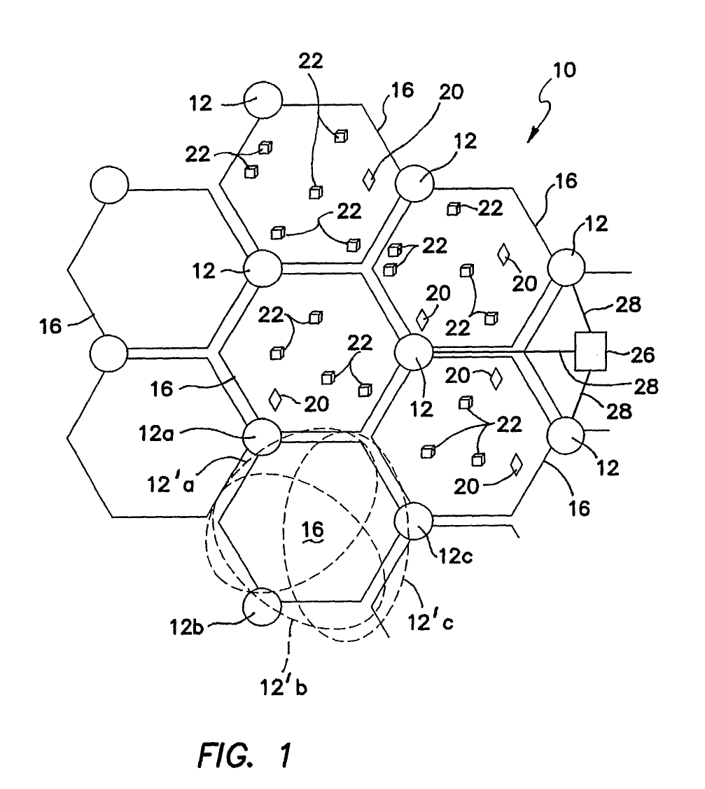

FIG. 1 depicts in schematic form a group of cellsites 12 comprising part of a larger cellular communications network 10 and a number of cellular communications devices 20, 22 located in at least some of the cell areas 16 of coverage provided by the cellsites 12.

The cellular communications network 10 and cellsites 12 are configured with hardware and software operative for routing wireless calls and messages to mobile subscribers located within the area of coverage of the network and providing two-way communications with cellular communications devices such as handsets 20 carried by the mobile subscribers. The area of service provided by network 10 is divided into contiguous cells 16. Coverage for each cell 16 is provided by a group of corresponding cellsites 12. For example, cellsites 12a, 12b and 12c each include radio transmitters with antennas which have a generally elliptical radiation pattern suggested by ellipses 12′a, 12′b and 12′c respectively, such that these three cellsites together cover the area of one cell 16 contained generally between the cellsites. A conventional cellular communications network 10 is normally configured for monitoring the presence and location of conventional two-way mobile handsets 20 relative to different cellsites 12, such that messages or calls addressed to mobile numbers assigned to the two-way handsets can be routed by a mobile telecommunications switching office 26 through trunk lines 28 to an appropriate cellsite 12 within radio communications range of the mobile handset 20 corresponding to that mobile number.

For purposes of the messaging system of this invention, cellular communications receivers or cellular broadcast receivers 22 are located within receiving range of the cellsites 12. Each cellular broadcast receiver 22 is configured to accept calls routed to a broadcast number. However, in one embodiment of the invention the cellular broadcast receivers 22 do not register with the cellular network by identifying themselves to any cellsites 12, and receivers 22 have no transmit capability at all so that many receivers 22 can operate in one cell 16 without interference or conflict. For purposes of this invention, a subset of cellular numbers, referred to here as broadcast subscriber numbers and which may be conventional ten digit mobile telephone numbers, is reserved for assignment to a special category of subscriber, which is here referred to as a broadcast subscriber. The cellular network 10 is configured through appropriate modification of either hardware, software or both, to make calls to any of the reserved broadcast numbers without testing for the presence of mobile cellular receiving units 22 pertaining to the cellular broadcast numbers. The cellular receivers 22 are each configured to accept calls placed to one or more of the cellular broadcast numbers. Multiple broadcast subscribers are assigned different broadcast numbers. Each broadcast subscriber is able to send messages to a group of recipients, each recipient in that group being equipped with a cellular receiver 22 programmed to answer calls placed to that broadcast subscriber's cellular broadcast number. Different broadcast subscribers can reach different groups of broadcast recipients. Conversely, each subscriber may be included in different recipient groups by programming that subscriber's cellular receiver 22 to answer calls directed to more than one cellular broadcast number.

Calls placed to a cellular broadcast number from a conventional telephone, either landline or cellular, are transmitted by one or more cellsites 12 without verifying the presence of a mobile handset 20 or receiver 22 corresponding to that broadcast number in the cells 16 covered by those cellsites 12. When operating in this broadcasting mode the cellsites 12 are referred to as broadcasting cellsites, although physically they may be the same cellsites 12. The cellsites 12 can operate in both conventional two-way private communication with individual subscribers, or broadcast mode for one-way transmission of messages from one caller to groups of recipients whose identity or presence is not necessarily known or detectable to the cellular network 10. Consequently, the one-way message broadcasting aspect of the cellular network may coexist with conventional two-way mobile communications on a given network 10.

Multiple such receivers 22 may be configured to accept calls addressed to a same broadcast number by any broadcast cellsite 12, such that multiple receivers 22 in the same cell 16 may receive a call placed to a single cellular broadcast number. A particular broadcast call or message may be broadcast by multiple cellsites 12 to cover multiple cells 16, each containing multiple receivers 22 programmed to answer to the same broadcast number, for a wider geographic area of message reception. Also, broadcast calls may be stored by the cellular network system 10 for subsequent broadcast through one or more cellsites 12, for example, during off-peak times of network usage or to take advantage of momentary frequency availability.

The number of cells 16 covered by a cellular broadcast may be determined by the requirements of the broadcast subscriber, for example, as part of a subscription agreement with the cellular network service provider. The broadcasting cellsites 12 may be chosen, for example, to cover a geographic area populated by a given group having a common interest or belonging to a common organization such as a school or church. In such case the broadcast subscriber may be the school or church which is interested in efficiently communicating with its student body or congregants, respectively. In such organizations a large proportion of the group typically resides in general vicinity to the school or church. A cellular message may be delivered to all or most members of the group, when each is equipped with a cellular communications receiver 22, with a single telephone call placed to the broadcast number assigned to that broadcast subscriber by the cellular network service provider, from any telephone, whether landline or cellular, from anywhere in the world where phone service is available. The number of cellsites 12 accessible by the broadcast subscriber may be a single cellsite 12 for limited local coverage or may include many cellsites 12 if wider area message delivery is needed.

In typical cellular communications networks 10 the cellsite 12 sets-up a two-way call or communication session with a mobile handset 20 by assigning available frequencies or channels for the communication session, including a receive frequency and a transmit frequency for the mobile handset 20. The cellular receivers 22 used in this first embodiment of the present invention lack transmission capability, so that no assignment of transmit frequency is needed. However, the receivers 22 may be responsive to communications channel assignment control signals transmitted by the broadcasting cellsites 12, such that the receiver 22 switches to a receive frequency assigned for the particular broadcast by the broadcasting cellsite 12, so that the cellular broadcast can be made over a frequency then available to the broadcasting cellsite 12. This assignment of receive frequencies by the cellsite 12 can be made in the conventional manner currently employed with conventional two way mobile telephone handsets 22, for example.

The cellular receivers preferably have message storage capabilities, such as digital storage, for subsequent replay of received messages.

In one embodiment of the invention the cellular receivers 22 are stand alone units with built in message playback capability, including for example, audio playback of voice messages, and for this purpose may have an audio amplifier and loudspeaker as part of the receiver unit.

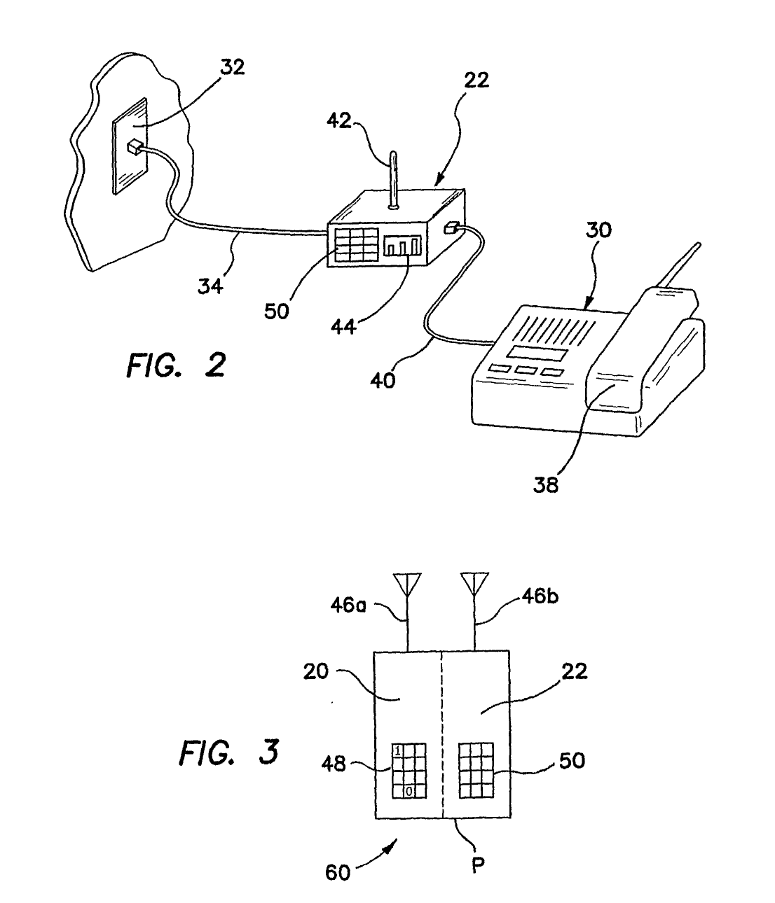

In another embodiment of the invention, illustrated in FIG. 2, the cellular broadcast receiver 22 is a unit equipped with a cellular antenna 42 and interconnected with a telephone answering device 30 of the type commercially available for answering calls made to landline telephones and storing voice messages for subsequent replay. In the illustrated example, answering device 30 includes a wireless handset 38. In this embodiment the cellular receivers 22 may be configured for receiving operating power from a landline telephone jack 32. Receiver 22 has a message storage capability, such as a digital storage, for storing receiver cellular broadcast messages. The receiver 22 is programmed to periodically download the received cellular broadcast messages, which are initially stored in receiver 22, via cord 40 for storage on answering device 30 for subsequent replay by the answering device 30. In such a system, messages received over the telephone land line 34 and the cellular broadcast messages received by the cellular receiver 22 may both be replayed in response to the message replay function of the answering device 30. In a variant of this latter embodiment, the cellular receivers 22 may be built as a single unit together with the landline telephone answering device 30, for example, in a common housing containing the necessary power supplies for both cellular receiver and answering device.

The cellular receiver 22 may be provided with an interface to the conventional answering device 30. The interface tests for availability of a dial tone from jack 32 to ensure that no landline telephone call is in progress that will be interrupted by offloading of the stored cellular broadcast messages. The interface may also take the landline telephone line “off-hook” while actuating the answering device 30 and offloading messages from cellular receiver 22. In FIG. 2, the receiver 22 includes appropriate switching for normally connecting answering device 30 to phone jack 32 and bypassing the receiver 22, and temporarily interrupting this connection for downloading stored cellular messages from receiver 22 to answering device 30. The answering device 30 need not differentiate between messages conventionally received via the telephone line 34 and messages received via the cellular receiver 22. Both types of messages are heard in the usual manner by activating the “play messages” function of the recipient's answering device 30. In this configuration this system operates with commercially available answering machines 30 of any brand or design without special setup or modification other than the connection of the cellular radio receiver 22 to the answering machine 30, normally between the recipient's incoming telephone line 34 and the answering machine 30, as shown.

The cellular broadcast receivers 22 may be preprogrammed for answering to one or more broadcast numbers, such that a given cellular receiver 22 may be used to receive messages from various broadcast subscribers representing different organizations of interest to the particular recipient. The cellular receivers 22 may be reprogrammable by end users for answering cellular calls placed to different or additional broadcast numbers, and for this purpose may have a numerical keypad 50, indicated in FIGS. 2 and 3 or other suitable input device.

In yet another embodiment of the invention, the cellular receivers 22 are modified to include a transmitter section capable of reporting the presence of the receiver 22 to a broadcasting cellsite 12 and registering with the network 10 in a manner similar to the reporting capability of existing two-way mobile telephones. In this embodiment the cellular receivers are registered with the cellular service provider in a manner analogous to the registration of two-way mobile telephone handsets, although multiple cellular broadcast receivers 22 are still configured to automatically accept, receive or answer calls or messages addressed to a given broadcast number. The broadcasting cellsites 12 in this embodiment can track the cellular receivers present in each cell 16, for example, for census or billing purposes.

In still other embodiments of the invention, a two-way cellular telephone unit such as a mobile handset 20 is modified so as to incorporate the functions of cellular receivers 22 of this invention without prejudice to its normal two-way functionality. For this purpose a separate cellular broadcast receiver 22 subsystem such as described above is included in the housing of the two-way cellular telephone unit 20 and configured to function independently of the two-way subsystem. Alternatively, the cellular receiver section of a two-way cellular telephone unit 22 is modified to also operate in a one-way messaging mode by automatically responding to cellular calls placed to a preprogrammed broadcast number.

The cellular broadcast receiver 22 may be physically combined or integrated with a conventional two-way cellular communications device 20 such as a mobile cellular telephone unit, as suggested in FIG. 3. The combination or integration of the two units may be of different degrees. For example, the two devices may be electronically independent units but combined into a single package P and sharing a common power supply such as a common battery. Alternatively, some circuits and components may be shared among the two devices 20, 22, such as audio stages and one or more audio transducers. Still other circuits may be shared in part or in whole, including radio frequency, analog and digital circuits as may be appropriate for efficiency and economy of manufacture, operation and packaging. The combined device 60 is shown with two keypads, a conventional keypad 48 for the two-way cellular communications device 20 and a separate keypad 50 for entry of user selected cellular broadcast subscriber numbers. These two keypads can, however, be integrated into a single multipurpose keypad.

In this embodiment the two devices 20 and 22 may remain functionally separate and independent, each provided with a radio antenna 46a, 46b respectively, such that the two-way cellular communications device 20 operates in a conventional manner without regard to the status or operation of the cellular broadcast receiver 22. In this configuration, a user of the combined device of FIG. 3 may carry on two-way communication such as a two way voice telephone call, while the cellular broadcast receiver 22 is in a standby mode for receiving cellular broadcast messages or actually receiving such a message. In the preferred form of the invention the cellular broadcast receiver 22 is configured to automatically accept cellular broadcast messages directed to the broadcast subscriber number preprogrammed in the receiver 22 without intervention by a human user and is provided with message storage capability for storing such automatically accepted cellular broadcast messages, including voice messages, for subsequent replay. Alternatively, a user may listen to or read incoming cellular broadcast messages in real time, and the cellular broadcast receiver 22 may be set in either mode by the user.

In an embodiment where the cellular broadcast receivers 22 lack are only capable of receiving cellular communications and lack any transmit capability there is no verification that particular cellular broadcast messages have been received by those broadcast receivers 22 programmed to receive those messages. Some receivers 22 of a target group of broadcast recipients may be out of cellsite range or disabled for one reason or another at the time of a given transmission, and consequently will fail to receive particular broadcast messages. Such a system may nonetheless be acceptable and useful for distribution of non-critical messages. Given that information can be disseminated rapidly and potentially at low cost by means of such cellular broadcast system, a less than perfect reception rate can be acceptable for many types of information.

As an aid to reduce missed messages, the broadcast receiver 22 may be provided with a visual or audible indicator 44, shown in FIG. 2, for confirming cellsite signal availability conducive to reception of cellular broadcast messages, or conversely, to signal loss or interruption of cellsite signal availability so as to alert a user that reception of cellular broadcast messages is lost so that steps may be taken to restore cellsite signal reception. Such an indicator 44 may be particularly useful with stationary cellular broadcast receivers 22, such as those used at a fixed location such as a residence. In such location cellsite signal availability is relatively stable and predictable as compared to a mobile cellular receiver, and once signal availability is established and confirmed by indicator 44 reception of cellular messages will tend to remain generally reliable provided the receiver 22 is not moved significantly.

For more positive control and verification of message reception, the cellular broadcast receiver 22 may be provided with limited transmit capability sufficient for registering with local cellsites 12 of the cellular network 10 but without capability for transmission of communication input generated by the user of receiver 22, such as transmission of voice.

The receivers 22 may be either preprogrammed for responding to one or more cellular broadcast subscriber numbers or may be user programmable for responding to user selected cellular broadcast numbers. In the first case, a receiver registry may be kept by the cellular network associating receiver identifying data, such as receiver serial numbers, with the broadcast subscriber number or numbers for which each receiver 22 is preprogrammed. In the latter case, but also in the first case, each receiver 22 can be configured for transmitting a receiver identification code or datum together with the broadcast subscriber number or numbers for which that receiver 22 has been either preprogrammed or user programmed.

Furthermore, the receiver 22 is also provided with capability for returning data to the cellsite acknowledging reception of particular cellular broadcast messages. For this purpose, each cellular broadcast message is encoded or otherwise provided with message identification data which is returned by the transmitter section included in receiver 22 to one or more cellsites 12 to acknowledge receipt of specific messages.

A list is compiled by a server or other data processing system associated with the network 10, for example at switching station 26 or other appropriate location, where confirmations containing message identification data returned by receivers 22 to the network 10 is correlated with receiver identification data and broadcast subscriber numbers programmed in each of the receivers 22. From this list the server under control of appropriate algorithm compiles a sublist of receivers 22 which failed to acknowledge receipt of specific messages directed to broadcast subscriber numbers programmed in those receivers 22. This list of missed recipients may then be acted upon in various ways by the network 10, or provided to the corresponding broadcast subscriber for appropriate follow-up action of his or her choice.

Implementation of the various embodiments disclosed above can be accomplished by those having an ordinary level of skill in cellular communications network engineering or related technologies, based upon the foregoing description, without an undue degree of experimentation.

Particular embodiments of the invention have been described for purposes of clarity and example. It will be understood, however, that many changes, modifications and substitutions to the described embodiments will be apparent to those having only ordinary skill in the art without thereby departing from the scope of the invention as defined in the following claims.

What is claimed is:

1. (canceled)

2. A wireless messaging system comprising:
a cellular radio communications network including a plurality of cellsites for routing wireless messages to a subscriber number within a geographic area of coverage of said cellsites; and
a plurality of cellular radio communications receivers distributed within said geographic area of coverage each configured to accept messages to the same said subscriber number such that a wireless message sent to a single subscriber number is received by multiple ones of said cellular radio receivers;
wherein said cellular communications network is configured for transmitting messages to said subscriber number through more than one of said cellsites substantially simultaneously such that said receivers in range of more than one of said cellsites may be addressed by a call to a single subscriber number.

3-6. (canceled)

7. The system of claim 1 wherein said receivers are configured for receiving operating power from a landline telephone jack.

8. The system of claim 7 wherein said receivers are configured for downloading stored messages to a conventional telephone answering device.

9. The system of claims 1 through 8 wherein said cellular communications network is configured to transmit calls placed to selected ones of said subscriber numbers without first detecting a signal indicating the presence of cellular handsets assigned the selected subscriber numbers.

10. The system of claim 9 wherein said cellular communications network is configured to transmit calls placed to said selected ones of said subscriber numbers substantially simultaneously through more than one of said cellsites for greater coverage.

11-12. (canceled)

13. A method of operating a cellular communications network of the type having a plurality of cellsites for routing wireless messages to any of a plurality of subscriber numbers within a geographic area of coverage of said cellsites, said method comprising the steps of:
providing for a first type of wireless communications requiring polling of mobile cellular handsets within said geographic area of coverage wherein each of said handsets is assigned a unique subscriber number, such that wireless messages may be directed to a selected one of said mobile cellular handsets; and
providing for a second type of wireless communications wherein wireless messages may be directed to any of certain subscriber numbers without polling for mobile cellular handsets assigned any of said subscriber numbers, such that multiple of said mobile cellular handsets within said geographic area of coverage may be programmed to concurrently accept individual messages directed to any one of said certain subscriber numbers, whereby an individual wireless message may be directed to multiple ones of said cellular handsets in said geographic area of coverage by dialing a single one of said certain subscriber numbers;
wherein said first and said second type of wireless communications are provided for simultaneously on said cellular communications network.

14. The method of claim 13 wherein said certain subscriber numbers are user programmable in said mobile cellular handsets, such that users may program said handsets to accept messages directed to a user selected one or more of said certain subscriber numbers.

15. The method of claim 13 or claim 14 wherein said certain subscriber numbers are reserved for said second type of wireless communications.

16. The method of claim 13 through 15 wherein said method comprises the step of assigning unique ones of said certain subscriber numbers to each of multiple broadcast service subscribers, such that individual messages sent by each of said broadcast service subscribers may be received by multiple ones of said mobile cellular handsets programmed to accept messages directed to the unique certain subscriber number assigned to any one of said broadcast service subscribers.

17. A mobile handset for use with a cellular communications network, said handset comprising:
a radio transceiver programmed to transmit unique handset identification to cellsites of said network and a radio receiver programmed to accept wireless cellular calls directed to a first cellular subscriber number uniquely assigned to said handset; and
a cellular broadcast receiver operable concurrently with said radio transceiver and programmed for accepting wireless cellular messages directed to a second cellular subscriber number not uniquely assigned to said handset,
wherein said cellular broadcast receiver is interfaced to said radio transceiver such that the reception of cellular messages by said cellular broadcast receiver is acknowledged by said radio transceiver to cellsites of said network.

18-20. (canceled)

21. The mobile handset of claim 17 wherein said cellular broadcast receiver is interfaced to said radio transceiver such that the reception of cellular messages by said cellular broadcast receiver is acknowledged by said radio transceiver to cellsites of said network.

22. The mobile handset of claim 17 claim 21 wherein said cellular broadcast receiver is interfaced to said radio transceiver such that said second cellular subscriber number is reported by said radio transceiver to said cellular communications network.

23. The mobile handset of claim 17 claim 22 wherein data processor associated with said cellular communications network are operative for compiling a list wherein said first cellular subscriber number is associated with said second cellular subscriber number for each said handset within a geographical area of coverage if said cellular communications network.

24. The mobile handset of claim 17 claim 21 wherein said cellular communications network further comprises a list wherein said first cellular subscriber number is associated with said second cellular subscriber number, and a data processor associated with said network and programmed for verifying reception by said handset of particular messages directed to said second cellular subscriber number.

25. The mobile handset of claim 24 wherein said data processor is operative for generating a list of verified recipients of particular messages directed to said second cellular subscriber number.

26. The mobile handset of claim 17 wherein said cellular broadcast receiver is programmed for automatically accepting and storing wireless cellular messages directed to said second cellular subscriber number without human intervention.

27. The mobile handset of claims 17 and 23 through 25 wherein said cellular network is operative for routing a message directed to said second cellular subscriber number through cellsites chosen based on polling of the radio transceivers of mobile handsets associated with said second cellular subscriber number.

28. The mobile handset of claims 17 and 23 through 25 wherein said cellular network is operative for repeating transmission of broadcast messages upon polling of radio transceivers of mobile handsets associated with said second cellular subscriber number which did not verify reception of an earlier transmission of a given broadcast message.
